(19) United States
(12) Patent Application Publication
(10) Pub. No.: US 2004/0034543 A1
(43) Pub. Date: Feb. 19, 2004

(54) Methodology to design, construct, and implement human resources business procedures and processes

(75) Inventor: Frank C. Bartsch, Leesburg, VA (US)

Correspondence Address: ROTHWELL, FIGG, ERNST & MANBECK, P.C., 1425 K STREET, N.W., SUITE 800, WASHINGTON, DC, 20005, US

(73) Assignee: Koninklijke Ahold NV

(21) Appl. No.: 10/342,345

(22) Filed: Jan. 15, 2003

Related U.S. Application Data
(60) Provisional application No. 60/347,900, filed on Jan. 15, 2002.

(51) Int. Cl. G06F 17/60

(52) U.S. Cl. 705/1; 705/11

(57) ABSTRACT

A methodology to design, construct, and implement human resources business procedures and practices is disclosed. The disclosed methodology discovers a business process by performing business process engineering and receiving information pertaining the business process. The information can be variables, deliverables, and other parameters. The disclosed methodology also constructs the business process according to the information. The disclosed methodology also implements the business process and an organizational efficiency model developed according to the business process engineering. The disclosed methodology also improves the business process according to key performance indicators from the information. The business process may be depicted as a flow to include the responsibilities of the process. Further, scenarios within the process are tested.

### CROSS REFERENCE TO RELATED APPLICATIONS

This application claims benefit of U.S. Provisional Patent Application No. 60/347,900, entitled “Methodology to Design, Construct, and Implement Human Resources Business Procedures and Processes,” filed Jan. 15, 2002, which is hereby incorporated by reference.

### BACKGROUND OF THE INVENTION

1. Field of the Invention

The present invention relates to a methodology for defining human resources (“HR”) processes to be used in business with an opportunity to re-engineer existing functional business areas or across functional business areas by design, construction, and implementation of the defined HR processes.

2. Discussion of the Related Art

Present day companies seek to improve processes and operations to get work done more efficiently and productively. Companies may execute various actions to improve the processes and operations. Some of these processes may concern HR processes that improve the functions of the HR department. These processes, operations, functions and jobs may be improved by implementing a consistent course of action throughout all the HR departments of a company.

### SUMMARY OF THE INVENTION

Accordingly, the present invention is directed to a methodology to design, construct, and implement human resources business procedures and processes.

Businesses and companies may use processes to get work completed. A process may be defined as a series of activities that move from a start point to an end point using individual process steps known as process objects. The process may be modeled as a diagram wherein the process objects represent an activity to be completed before another activity starts. Thus, a series of discrete processes may comprise an overall business process. For a specific type of business process, the discrete processes may be defined to give the optimal result for the task being done. By using this information, business processes may be created, implemented, and optimized.

Additional features and advantages of the invention will be set forth in the disclosure that follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a method for designing and implementing human resources business procedures within a company is disclosed. The method includes discovering a business process by performing business process engineering and receiving information pertaining to the business process. The method also includes constructing the business process according to the information. The method also includes implementing the business process and an organization efficiency model developed according to the business process engineering. The method also includes improving the business process according to key performance indicators from the information.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings:

FIG. 1 illustrates a flowchart of a methodology to design, construct, and implement human resources business procedures and processes according to the disclosed embodiments;

FIG. 2 illustrates a flowchart for the discovery phase according to the disclosed embodiments;

FIG. 3 illustrates a flowchart for the construction phase according to the disclosed embodiments;

FIGS. 4a-f illustrate a flowchart for user acceptance testing according to the disclosed embodiments; and

FIG. 5 illustrates a flowchart for the implementation phase according to the disclosed embodiments.

### DETAILED DESCRIPTION OF THE PREFERRED EMBODIMENTS

Reference will now be made in detail to an embodiment of the present invention, examples of which are illustrated in the accompanying drawings.

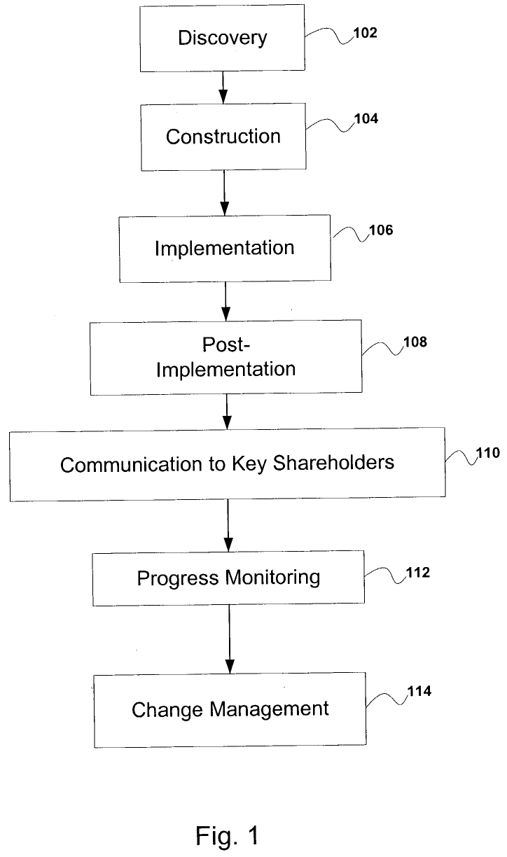

FIG. 1 depicts a flowchart of a methodology to design, construct, and implement human resources business procedures and processes according to the disclosed embodiments. Execution of the disclosed HR methodology may include four phases: Discovery, Construction, Implementation, and Post-Implementation. Additional aspects of the HR methodology may include progress monitoring, project plans, and other aspects of the methodology. According to the disclosed embodiments, an organization hierarchy may be designed that supports the work to be done, and the strategic and tactical business objectives of the organization. Organization efficiency may be increased and the full time equivalent usage may be maximized be reengineering job descriptions and job roles, determining knowledge and skills, determining the hay grade, and developing an organizational structure/hierarchy that best supports the work being done.

The process begins at step 102 executes the discovery phase of the disclosed embodiments. Step 104 executes the construction phase. Step 106 executes the implementation phase. Step 108 executes the post-implementation phase. Step 110 executes the communication to key shareholders phase. Step 112 executes the progress monitoring phase. Step 114 executes the change management phase. Each step is disclosed in greater detail below.

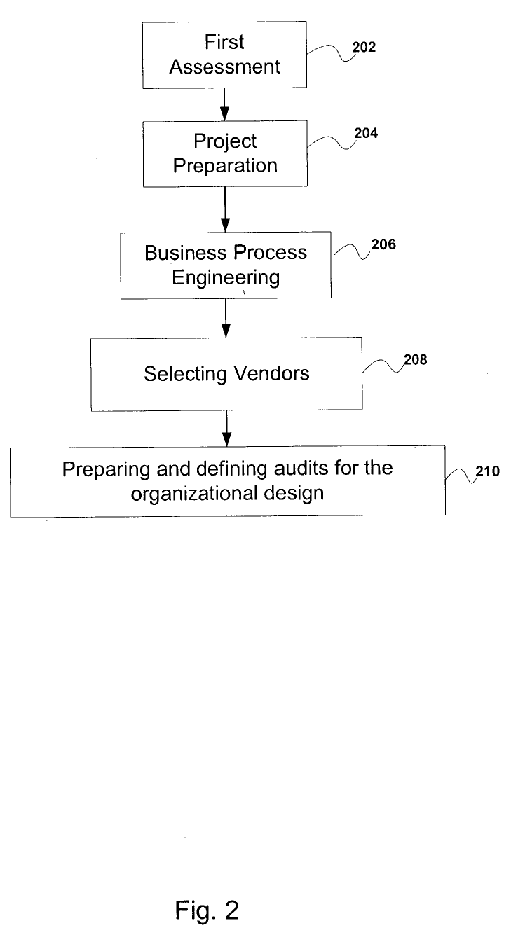

FIG. 2 depicts a flowchart for the discovery phase according to the disclosed embodiments. FIG. 2 may disclose step 102 of FIG. 1 in greater detail. Step 102, however, is not limited to the disclosure pertaining to FIG. 2. In FIG. 2, step 202 executes the first assessment operation of the discovery phase. First assessment is the preparation to build the business case and to identify the return on the investment for the new HR design, construction and implementation of the business processes. First assessment may include a business information analysis. A business information analysis seeks to determine certain parameters of existing HR business processes, including time, frequency, volume of HR transactions, resource, organization, and error ratio. Time parameters may include activity life cycle, weekly hours, and weekly volume. Frequency parameters may include days per week, or weeks per month that a process or event occurs. Error ratio and rework may include manual vs. automated activities, internal and external manual hand offs, and rework hours.

Step 204 executes the project preparation operation of the discovery phase. Several actions may occur under project preparation, such as selecting business team members, preparing a project charter, and preparing the project plan for the later phases. For example, a business team should be composed of information technology representatives and business representatives with a multidisciplinary background. Each business unit/organization should be represented that will implement newly designed processes, preferably with subject matter experts (“SME”). Other activities may include creating guiding working principles for the newly composed team, creating strong relations with leadership in all participating companies and organization, preparing a project steering committee, and finalizing the business information analysis. The project charter may identify the needs and benefits of the project, major product deliverables, constraints and assumptions, staffing needs, and the like.

Step 206 executes the business process engineering operation of the discovery phase. Business process engineering may include several key actions. An HR context model may be created that includes several key aspects. Process redesign may be defined as identifying, documenting, analyzing, and improving a process. Process redesign seeks to create standard processes in all participating companies organizations. Differentiation from the designed process should be acceptable only in the case of a legal, contractual, and/or regulatory issue. A sequence for business process engineering may include defining and preparing for the project that will use the process. Critical business issues may be defined, such as managers spending too much time on human resources paperwork. Project goals and scope may be established. Critical processes may be selected for business process engineering. In selecting critical processes, processes should be chosen that are the least effective and efficient at producing desired outcomes, have the greatest impact on volume, and provide the best balance of potential payoff and success. A project plan may be developed to determine project support requirements and project constraints. Project roles may be identified and the project may be initiated.

A business process may be depicted by a business model that provides an abstract representation to display properties and behaviors. The discrete processes and model should be generated and defined early in the development of the business project. Embodiments of the present invention disclose a methodology to formulate and implement the discrete processes and the business model in an efficient and timely manner, while reducing latency and redundancy in the individual business processes.

The business process engineering sequence may include redesigning to determine and capture the triggers that begin the business process and define the outcomes of the process. Approaches to redesign may include identifying and naming the process being redesigned, identifying triggering incidents that begin the process, identifying the outcomes that result when the process is completed, identifying the roles of persons and departments taking part in execution of the process, and documenting the information captured above. As noted above, business process engineering seeks to improve upon an “AS IS” process and implement a “TO BE” process. The AS IS system may be analyzed for the business process engineering sequence. At the organization level, organization context diagrams should be constructed and critical business issues and critical processes confirmed. At the process level, the current AS IS process should be mapped and potential disconnects identified and analyzed. At the procedural level, the detailed functional and technical activities and task may be identified.

The process may be known as an “AS IS” map. An AS IS map depicts the flow of work that currently is performed by the business in response to an event and documents interactions between roles and organization areas. In analyzing the process, a start point and end point for each map should be defined.

“AS IS” also may be known as current process grounding that seeks to gain a common understanding of the current process, outcomes, and triggers. “AS IS” process grounding also may seek a description of how things are completed at the present time. Further, current process grounding may seek a reference point for the new process during development from which to measure effectiveness. Several approaches may be used during current process grounding to identify parameters and understand the process, such as identifying current process triggers, identifying key process outcomes for the current process, identifying major activities within the current process, developing a list of the current process problems or areas to be improved upon, and capturing metrics and measures for the current process.

Business process engineering seeks to enhance the organization with a “TO BE” process that may be implemented. Several processes may be implemented and enhanced through business process engineering according to the disclosed embodiments. A new process may be designed, or an existing process redesigned according to the disclosed embodiments. The business team and subject matter experts that represent different companies may perform the process, as disclosed above. The business team and SMEs may work together to implement the To Be process in each organization. SMEs also may coordinate change management activities because SMEs should be aware of the differences between current practices and the newly designed processes. The resulting process may support business goals and meet customer expectations. The resulting process also may be fast, focused and flexible. A workgroup may be organized with the collective expertise to plan, coordinate, control, and troubleshoot its own work.

The disclosed embodiments may achieve these objectives by minimizing nonvalue added steps within the processes. The disclosed embodiments also may minimize mid-process handoffs to discrete entities that may result in delay and error. The disclosed embodiments also may minimize second party approvals. The disclosed embodiments also may minimize unnecessary authorization steps that result in delay. The disclosed embodiments also may minimize manual reconciliation, promote automatic reconciliation to quicken the processes, and decrease error ration. Moreover, the disclosed embodiments may harness technology by maximizing the value derived from a computer network investment and providing universal access to information at the right time.

For example, a business process may be generated according to the disclosed embodiments for the hiring processes of the different operating companies (“OpCos”). The OpCos then implement the new hiring process at their distinctive stores. As noted above, the process preferably is implemented on a computer network linked to computers in other stores, and to a central computer or server network for the OpCo. For example, each store may have a computer terminal, or kiosk, that accesses the network supporting the business process. This network may be known as the human resources information system (“HRIS”).

A conceptual flow diagram may be created within the business process engineering sequence according to the disclosed embodiments. A conceptual flow, or process, diagram may be an easy-to-communicate, pictorial description of the redesigned process that captures the significant process changes. The conceptual diagram may be used to communicate the redesign process to key stakeholders. Approaches to forming the conceptual flow diagrams may include listing and describing the significant process changes, developing a graphical representation of the significant process changes, and an understanding of the new process.

The process should have at least one input and at least one output. Outputs may be defined as services delivered, including cost, quality, and timeliness. Outputs may include form, content, and frequency of information. Inputs may include information, materials, and equipment. The process also may have throughputs, such as the primary parties involved, the number of hand-offs between parties, and technologies and methods used, anticipated, or required.

Standardized symbols with descriptions should be used for mapping. The map should follow a logical flow and note a time value for each step. Disconnects within the process should be identified. Process analysis should flag or identify problems, illogical inputs or outputs to the workflow process, and/or missing or redundant processes between roles or the organizational areas within the business. In other words, any activity that qualifies should inhibit the effectiveness and/or efficiency of the process. Key areas of focus for process analysis may include value, quality, quantity, timeliness, completeness, and accuracy.

The business process engineering sequence may include process modeling. The process model may be the basic building block of the redesign, and may involve identifying and sequencing the major activities that link process triggers to process outcomes. Approaches to process modeling may include identifying the major activities required to link process triggers to process outcomes, identifying the metrics that will be used to measure the performance of the new process, transferring the major activities to media that may be arranged in order based on the process flow. Other approaches may include adjusting and altering the order of the activities to optimize critical measures for the process, determining a final process model by identifying dependencies, parallel activities, major decision points, and the like.

The resulting business processes and the attendant discrete processes implemented by business process engineering are configured to be executed on a network of computers supported by software configured for the processes. An organization may have one or more operating companies (“OpCo's”) that provide services and products to customers. The OpCo's may be different or similar in function and industry, and may implement the business process in different manners. For example, the OpCo's may be different chains of stores with their own employees. The OpCo's may be responsible for hiring, paying, providing benefits, and the like for their employees.

The business process engineering sequence may include determining detailed requirements. An example of the detailed requirement may be a “Procedural Questionnaire checklist.” Detailed requirements help to refine the business process into specific task or decisions through successive levels of detailing. The detail requirements also may facilitate development of blueprints of job/skill/organization/IT/management systems in the construction and implementation phases. Detailed process diagrams and descriptions may be used to communicate how the business process may operate in the future.

Several approaches may be used for determining detailed requirements. For each major activity with the disclosed methodology, a comprehensive list of events, decisions, and tasks may be created. The list may be transferred to a media and arranged according to a logical or optimal process flow. Each step or decision may be assigned a number after the order of activities is decided. When appropriate, opportunities may be identified to complete tasks in parallel. For each task, event, or decision, contingencies, issues, integration points, information requirements process measures, resource allocation, rules, and assumptions may be identified to be captured and recorded as to not lose or overlook this information. The process may be recorded after capturing all the detailed tasks and decisions, and arranging them into logical order. For unknown issues or areas where multiple solutions may exist, alternatives may be developed and noted on the new process diagrams.

For decision steps within the process model, additional information should be captured. The additional information may include decision criteria, variables or inputs to observe, information required to make the decision, location of the information (either specific computer system or individual), communications outputs of the decisions and their locations, decision rules, legal or regulatory restrictions, organizational restrictions, decision frequency, and the like. After capturing this information, the data may be documented.

In capturing the information to define the processes, the disclosed embodiments of the business process engineering may use checklists and questionnaires. The questionnaires may inquire as to who performs the process or procedure, what the process or procedure does, what prompts it to be performed and how it is performed, and the like.

An example questionnaire for business process engineering may be disclosed below. The questionnaire may be completed during the assessment phase with the discovery phase disclosed above. The questionnaire may serve as a template for the business process engineering model and for further actions within the disclosed methodology. The questionnaire may be broken into fields that pertain to discrete subjects for that particular process. For example, the questionnaire may ask for procedure roles and responsibilities, which will be used in the organization efficiency during the implementation phase. The questionnaire also may ask for a procedure description that is used to create for the business functional specifications as requirements for HRIS during the construction phase. The questionnaire also may request procedure information, such as specialized skills needed, lead time, duration, and frequency to create training materials during the construction phase and to hold training during the implementation phase. Further, the questionnaire may ask for information on deliverables and performance measures to measure the success of implementation during the post-implementation phase.

Step 208 executes the selecting vendors operation of the discovery phase. This operation may be performed concurrently with the business process engineering operations. A request for information and a request for proposal may be used by the design teams to solicit potential vendors for construction of an HRIS to support the redesigned business process. Further, contract negotiation with selected vendors may occur in this operation.

Step 210 executes the preparing and defining audits for the organization design operation for the discovery phase. This operation includes preparing audit reports for use in later phases. The information for preparing the audit materials may be found in the questionnaire disclosed above. Audits may focus on the controls information within the questionnaire. Controls may be manual or automated. Preferably, controls should be automated. Further, controls may be detective or preventive. Using the controls listed in the questionnaire, audits may be defined and prepared by ensuring the controls are in place and functioning properly.

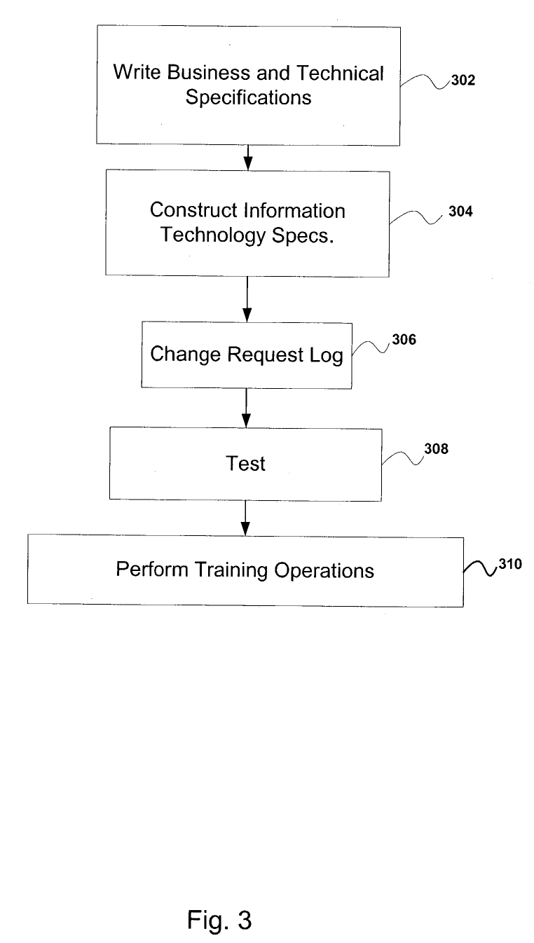

FIG. 3 depicts a flowchart for the construction phase according to the disclosed embodiments. FIG. 3 may disclose step 104 of FIG. 1 in greater detail. Step 104, however, is not limited to the disclosure pertaining to FIG. 3. The information for completing this phase may be found in the questionnaire disclosed above. Specifically, the procedure description information put in the questionnaire helps in constructing the methodology. The information desired for the construction phase may be what the described procedure will do, what prompts the procedure to be performed, and the steps in performing the procedure. Procedure information also may be a source for the construction phase.

Step 302 executes by writing business and technical specifications. Step 304 executes by constructing information technology specifications. These specifications may be used to implement the appropriate HRIS processes to support the procedures, or the methodology as it is being developed. In other words, if the methodology calls for a team to use various computer, peripherals, or other devices in implementing the procedures, then those requirements may be described here.

Step 306 executes by changing a request log that may be tied into risk assessment. A request log may document those issues or concerns that arise while implementing the business processes and IT system. These concerns and issues then may be tracked to see if they are resolved. In performing this operation, a risk assessment strategy may be developed.

Step 308 executes by testing. Testing includes unit testing, parallel testing, integration testing, and user acceptance testing. User acceptance testing is disclosed in greater detail below. User acceptance testing may define scenarios and test them. Testing operations may use scripts, wherein scripts are cases and exercises to promote the procedures developed by the disclosed methodology.

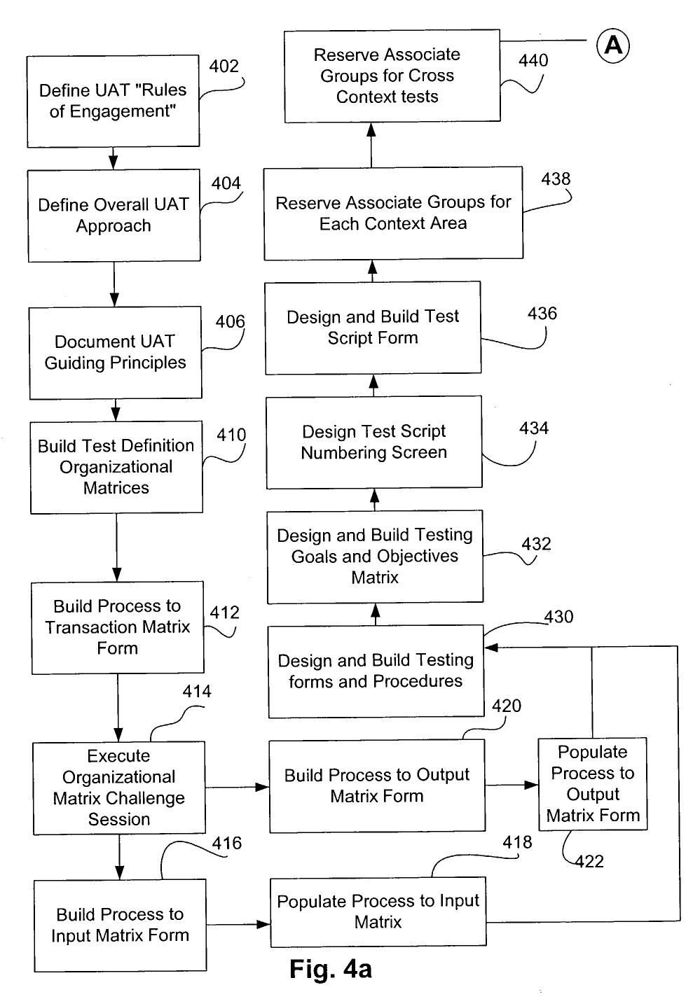

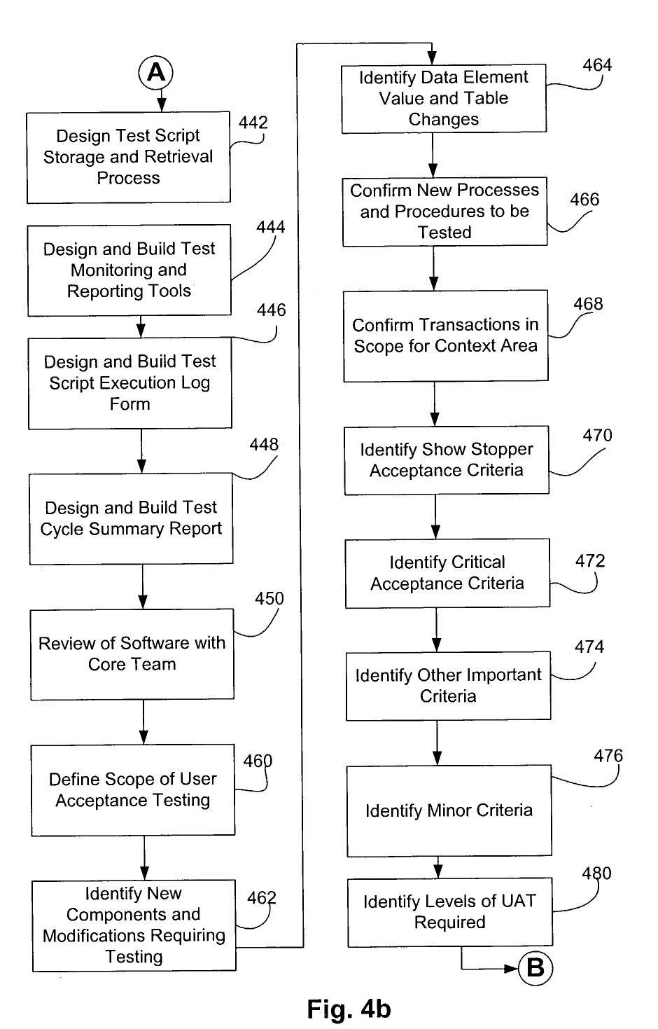

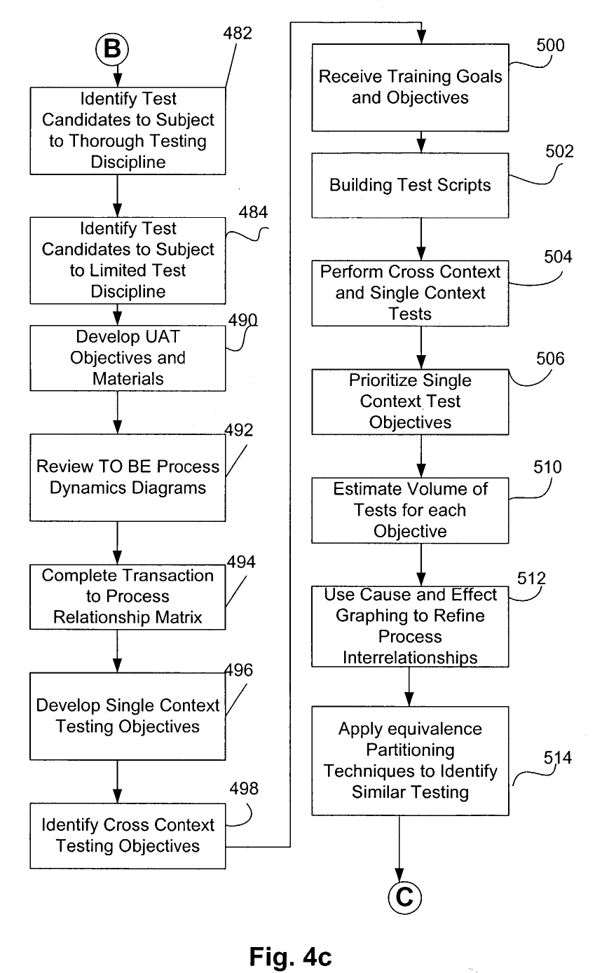

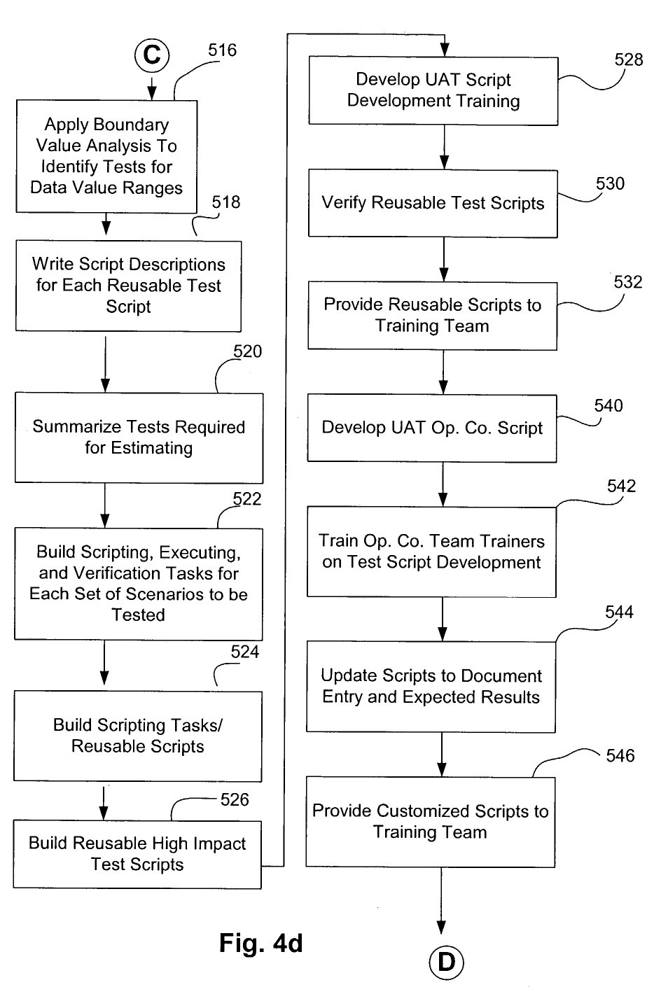

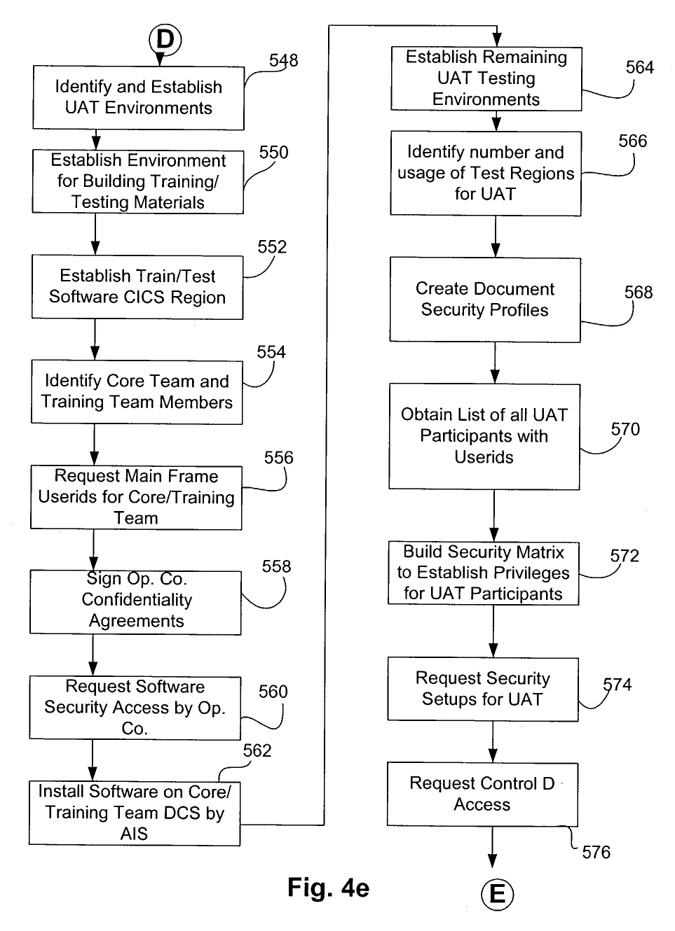

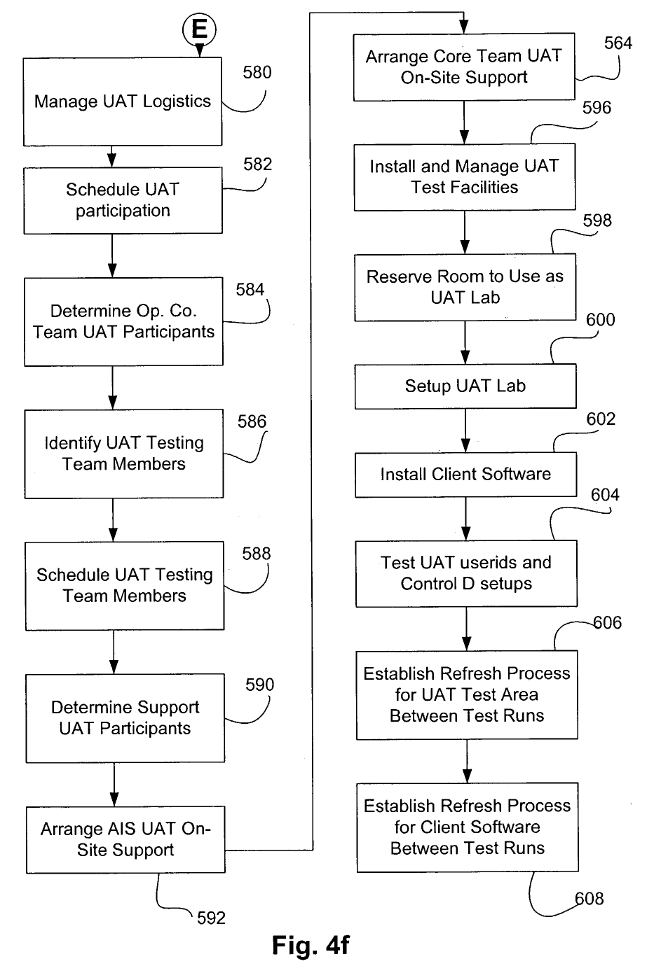

FIGS. 4a-f depict a flowchart for user acceptance testing according to the disclosed embodiments. The features disclosed with regard to FIGS. 4a-f are an example of one way to perform user acceptance testing according to the disclosed embodiments. User acceptance testing for the present invention is not limited to the processes disclosed below, and other processes for executing user acceptance testing may be apparent to those skilled in the art. Further, the steps disclosed below may be executed in a variety of ways, and is not limited to the sequence disclosed with regard to the flowchart.

Step 402 executes by defining an user acceptance testing (“UAT”) Rule of Engagement. This task may define how testing is to be conducted for this specific project. Step 404 executes by defining an overall UAT approach. Testing may be defined as to how to be approached. Alternatives may be custom building of test cases into a blank database, selecting test cases from existing, converted data, or a hybrid approach using both approaches. A deliverable of step 404 may be a testing approach document.

Step 406 executes by documenting UAT guiding principles. Guiding principles may be defined to inform levels of testing to be applied to different categories of transactions or data. Guiding principles also may inform management of exclusive groups of test records to ensure that each context team can control the test records, and ensure that the records may not be updated by other context teams. Guiding principles also may inform management of shared groups of test records where scripts define expected results of tests early in a testing sequence to match the starting conditions expected by the following tests. Management of test results may include recording tests that meet expectations, and those that result in discrepancies, notifying information systems (“IS”) of discrepancies, summarizing tests in terms of successfully executed tests, outstanding discrepancies and resolved discrepancies.

Step 410 executes by building test definition organizational matrices. Step 412 executes by building a process to transaction matrix form. This step may build a form to record the relationships between TO BE business processes and business transactions. Step 414 executes by executing an organizational matrix challenge session. Step 416 executes by building a process to input matrix form. This step may build a form to be used to document the relationship between TO BE business processes and the inputs used. Once populated, testers may identify where the input data originates and what screens may be accessed when writing test scripts. Step 418 executes by populating the process to input matrix.

Step 420 executes by building a process to output matrix form. This step may build a form to be used to document the relationship between TO BE business processes and the outputs produced. Once populated, the testers may identify the potential downstream impact of their tests. The process to output matrix form may identify where groups of test records may be shared across context teams to minimize the number of unique scripts that may be written and executed. Step 422 executes by populating the process to output matrix.

Step 430 executes by designing and building testing forms and procedures. Step 432 executes by designing and building a testing goals and objectives matrix. This step may design and build a form that may record testing goals, define testing objectives for each testing goal, identify the business impact of each testing objective, identify dependencies on the completion of the preceding test, and link the goals and objectives to groups of related testing scripts. Step 434 executes by designing a test script numbering system. The script numbering system, or scheme, may be used to uniquely identify each script, permit sample distribution of scripts for test execution, facilitate routing of discrepancies to appropriate development staff assigned to their resolution, and readily summarizing results by context area. Step 436 executes by designing and building test script form. This step may design and build a test script form. Depending on the testing approach, the form may record the initial state of the input to the test, field by field data entry instructions, and the expected results. The expected results may be defined both in terms of deliverables to be produced and reviewed, and the values of the fields in the deliverables. Alternatively, the script may define initial conditions to search in the converted database, and/or the directions on how to update an existing record to create the initial test conditions desired. The form also should contain a unique identifying number for this particular script and a place to record the identifying number of a script that may be successfully executed prior to executing this script.

Step 438 executes by reserving associate groups for each context area. Step 440 executes by reserving associate groups for cross context tests. Step 442, shown in FIG. 4b executes by designing a test script storage and retrieval process. This step may determine how test scripts are to be organized and stored so that the scripts may be easily found, may be readily grouped for printing, and may be sent to the OpCo to run the tests. Step 444 executes by designing and building test monitoring and reporting tools. Step 446 executes by designing and building test script execution log form. Step 448 executes by designing and building a test cycle summary report. A reporting form may be designed that summarizes the results of a given testing cycle. The reporting form may report, by context area, the total number of test cases, the number of test cases executed, the number of test cases where actual results match expected results, the number of discrepancies reported (i.e., the test cases where actual results differ from expected results), the number of discrepancies resolved, the number of outstanding discrepancies, various percentages relating to test completion and system quality, and the like.

Step 450 executes by reviewing software, or the computer network, with a core team. Step 460 executes by defining the scope of UAT. Step 462 executes by identifying all new components and modifications requiring testing. This information may come primarily from the functional requirements document and is summarized in the functional requirements control matrix. Step 464 executes by identifying data element values and table changes. These values may come from the data model and from technical specifications for edits. Step 466 executes by confirming new processes and procedures to be tested. Referring to a context model and process diagrams, the processes and procedures to be tested may be identified. A context model may be a high level, intermediate, and low level business functional areas. For example, Human Resources may be decomposed into intermediate business functions. Intermediate business functions may be decomposed into low level business functions.

Step 468 executes by confirming transactions in scope for a context area. The business transactions in scope for the context area may be determined by reviewing the process diagrams. A process diagram may be a graphical descriptions of business processes that uses standard symbols to show the sequence of activities that take place in the process, the data, information, or documents that are input to the process or generated output as a result of the process, and the decisions that are made at each point in the process. Step 470 executes by identifying show stopper acceptance criteria. This step acknowledges a zero tolerance for defects. Show stopper criteria may be defined as discrepancies that may be corrected before the system can go live. Further, any corrections should be working properly in all cases before going live. The zero tolerance is for unresolved testing discrepancies. If the new system results are different from the legacy, the new system's results may be accepted as being correct and the discrepancy with the legacy system being explained.

Step 472 executes by identifying critical acceptance criteria. This step acknowledges a very low tolerance for defects. Critical criteria functions should be accurate within a tolerance before going live. For example, critical criteria functions may be working in 99% of cases prior to going live. If the new system results are different from legacy results, the new system's results may be accepted as being correct and the discrepancy with the legacy system should be explained. For cases that are not working properly, results should be calculated to within about +/− two percent of legacy system results.

Step 474 executes by identifying other important criteria. This step acknowledges a moderate tolerance for minor defects. Important criteria may be functions that are accurate, within reason, before going live. Important criteria should be working properly in about 80% of the cases prior to going live. The important criteria should affect less than about 2% of the population and should result in discrepancies of no more than about 5% of total results for those people who are affected. Plans to fix should be expected to complete within about 30 days after going live.

Step 476 executes by identifying minor criteria. This step acknowledges a high tolerance for moderate level of defects. Minor criteria may be unresolved discrepancies that have little impact at going live. Minor criteria should affect less than 1% of the population. Minor criteria should affect only downstream interfaces, and not results. Plans to fix should be expected to complete within 90 days after going live.

Step 480 executes by identifying levels of UAT required. Step 482, shown in FIG. 4c, executes by identifying test candidates to subject to thorough testing discipline. Test candidates may include new components and modifications to vanilla, or basic, system. Test candidates also may include new functionality developed to support new interfaces, both input and output. Further, test candidates may include high volume and high risk/exposure business transactions. Moreover, test candidates may include high usage reference and look-up table entries. In addition, test candidates may include new high volume processes and procedures. Step 484 executes by identifying test candidates to subject to limited test discipline. Test candidates may include existing system functionality, unchanged in this release, and unmodified to support new processes and procedures. Test candidates also may include low volume transactions that have a low risk/exposure associated with them. Further, test candidates may include low volume/risk processes and procedures.

Step 490 executes by developing UAT objectives and materials. Step 492 executes by reviewing TO BE process dynamics diagrams. The review may look for notes and issues to make sure that items of key importance are incorporated into UAT. Step 494 executes by completing a transaction to process relationship matrix. Relationships between results of one process may act as a trigger for another. The relationship matrix may identify impacts on downstream processing, interfaces, and reports, and may be used later to document expected results and input to cause and effect graphs. Step 496 executes by developing single context testing objectives. This step may define the testing goals and objectives. A deliverable may be the testing goals and objectives matrix.

Step 498 executes by identifying cross context testing objectives. Step 500 executes by receiving training goals and objectives. Step 502 executes by building test scripts. Certain tests logically belong together. These tests may impact the same part of the system, such as screens and reports. The tasks that the functions support may be performed by the same people. The tests may have cause and effect relationships. The tests may occur at the same point in the weekly or monthly processing cycle. The results of this analysis are recorded in the testing goals and objectives matrix.

Step 504 executes by performing cross context and single context tests. Step 506 executes by prioritizing single context test objectives and prioritizing cross context test objectives. The tests for the show stoppers and critical acceptance criteria may be defined. Separating the objectives may help in prioritizing testing tasks in the project plan. Step 510 executes by estimating volume of tests for each objective.

Step 512 executes by using cause and effect graphing to refine process interrelationships. Cause and effect graphing may show relationships between causes, or input conditions, and effects, or actions to be taken by the system. For each cause, the effects may be listed and the expected results used to measure whether the correct actions were taken. The cause and its related effects may be documented in decision tables. Decision tables are useful documents for grouping test cases in the test documentation. Step 514 executes by applying equivalence partitioning techniques to identify similar testing. Equivalence partitioning may limit the number of unique test cases desired. Equivalence partitioning is the process of looking at groups of transactions and conditions that may be expected to perform the same way. For example, if a staff accountant is treated the same as other staff accountants, one test case may be devised to cover the accountants.

Step 516, shown in FIG. 4d, executes by applying a boundary value analysis to identify tests for data value ranges. Boundary value analysis may be used to test the upper and lower limits of ranges. A test case may be used at the top of the range, but within it. Another test case may be used immediately above the top of the range. Other test cases may be used at and immediately below the bottom of a range. Step 518 executes by writing script descriptions for each reusable test script.

Step 520 executes by summarizing tests required for estimating. Each of the above techniques may generate additional cases/scenarios that may be tested. The total number of test scripts desired may be estimated by using the rules of thumb for numbers of test cases and the number of possible condition needing to be tested. In later steps, the time per script and the number of downstream results to be checked may be used to determine the total time to develop scripts, the total time to run scripts, the total time to check results. The last two may be multiplied by the expected number of test execution cycles.

Step 522 executes by building scripting, executing, and verification tasks for each set of scenarios to be tested. A level of difficulty may be assigned to each script once those needing to be built have been identified and recorded on the testing goals and object matrix. Time may be estimated for scripts at each difficulty level. A spreadsheet may be used to calculate total effort for writing the scripts, running the scripts, checking results, and reporting discrepancies. The last two actions may be multiplied by the expected number of executions for each test.

Step 524 executes by building scripting tasks and reusable scripts. Step 526 executes by building reusable high impact test scripts. This step may build out the reusable scripts. The reusable scripts should be designed as much as possible to be able to be reused in testing subsequent implementations, or for regression testing at the same OpCo. The scripts may define what initial state is desired for testing, how to search for and identify candidate records, how to modify candidate records if none can be found in the initial state needed for this script to meet the testing objective, what ending state and other results are expected as outputs from the test, what outputs may be checked to verify expected results, and how each output is to be checked.

Step 528 executes by developing UAT script development training. Step 530 executes by IS verification of reusable test scripts. IS may review reusable scripts in a challenge session format. This review may identify any areas of the system that have not been targeted for testing, identify additional scripts needed for thorough testing, and verify the scripts for completeness and accuracy. Step 532 executes by providing reusable scripts to a training team. Step 540 executes by developing UAT OpCo scripts. Step 542 executes by training the OpCo team trainers on test script development. The session is desired to review the reusable scripts with key OpCo staff responsible for customizing scripts or supervising people that may customize scripts. The session also may train the key OpCo staff on how to customize the scripts and identify any additional testing objectives for which reusable scripts should be written. The session also may identify any additional testing objectives for what the OpCo specific scripts should be written. The session also may confirm the estimates of effort for completing the scripts and confirm the target dates for completing the scripts.

Step 544 executes by updating the scripts to document entry and expected results. The scripts may be adapted to the OpCo being tested. For each script, a test record may be identified in the converted database. The test record may be modified to bring it to the initial state desired to meet the testing objective. Each data element and value may be recorded to be entered on each screen. Specific expected results may be defined for each interface and a report produced. Each error message may be defined that is expected to be encountered on each negative test. Step 546 executes by providing customized scripts to the training team.

Step 548, shown in FIG. 4e, executes by identifying and establishing UAT environments. Step 550 executes by establishing an environment for building training and testing materials. Step 552 executes by establishing train/test software, or cyborg, CICS region. Step 554 executes by identifying core team and training team members. Step 556 executes by requesting mainframe userids for core/training team. Step 558 executes by signing OpCo confidentiality agreements. Step 560 executes by requesting software, or cyborg, security access by the OpCo. Step 562 executes by installing software, or cyborg, on core/training team personal computers by IS. Step 564 executes by establishing remaining UAT testing environments.

Step 566 executes by identifying the number and usage of test regions for UAT. Several test regions may be needed to support both UAT and parallel testing. A region may be desired for each of data conversion, UAT positive testing, and UAT negative or destructive testing. Step 568 executes by creating document security profiles. Role specific security profiles may be established for use during UAT for the OpCo staff participating in UAT.

Step 570 executes by obtaining a list of the UAT participants with userids. The OpCo testing participants are identified and their testing roles defined. The userids are desired as the first step in building the testing security matrix. Step 572 executes by building the security matrix to establish privileges for UAT participants. A security matrix may be built using the userids and roles and responsibilities as a guide. The security matrix may be submitted to systems security so that the appropriate access privileges may be built. Step 574 executes by requesting security setups for UAT from systems security. Security access requests may be submitted to systems security for access to cyborg test regions. Step 576 executes by requesting control D access from production control. Control D access requests and report distribution matrices may be submitted to systems security for access to test reports stored in Control D.

Step 580, shown in FIG. 4f, executes by managing UAT logistics. Step 582 executes by scheduling UAT participation. Step 584 executes by determining OpCo team UAT participants. Step 586 executes by identifying UAT testing team members. Each context area should identify the associates that may be testing the part of the system they are accountable for. Step 588 executes by scheduling UAT testing team members. Each context area should ensure the resources are assigned testing and are available when the tests should be run.

Step 590 executes by determining support UAT participants. Step 592 executes by arranging IS UAT on-site support. The IS development staff members that may be on site are scheduled during UAT and parallel testing. Step 596 executes by installing and managing UAT test facilities. Step 598 executes by reserving a room to use as UAT lab. A room may be designated the UAT lab for about 10-12 weeks. The room may be used for UAT and some aspects of parallel testing. The room should accommodate about 6 personal computers and up to about 10 people including the networking and power supply to support the personal computers. The room should include a whiteboard and some space to sort and review reports, and file cabinet space to store test scripts and test results.

Step 600 executes by setting up the UAT lab. This task may include installing furniture, personal computers, and networking and a printer for printing small reports and testing documents. Step 602 executes by installing client software. Unique icons may be setup to access each region to be used during UAT and parallel testing. Step 604 executes by testing UAT userids and control D setups. The HRIS userids should be tested at least 2 business days prior to the start of UAT. Each control D identification should be accessed to at least ensure it is present, even if there is no data to be viewed. Step 606 executes by establishing a refresh process for the UAT test area between test runs. The UAT regions may be refreshed with test data converted from HRIS prior to the start of each UAT cycle. Step 608 executes by establishing a refresh process for HRIS client software between test runs. The files used in conjunction with each test region should be refreshed prior to each test cycle to ensure that updates are reflected to the HRIS tables and codesets that have been made as a result of the test feedback.

Referring back to FIG. 3, step 310 executes by performing training operations. An information source for training may be the procedure information described on the procedural questionnaire checklist. This information may include any specialized skills desired to perform the procedure, any specific knowledge desired, lead time, duration, and frequency. Training may be directed towards the specific knowledge or skills desired to perform the procedure. Another aspect of this operation may be creating information technology documentation based upon the business procedure document supported by the procedural questionnaire. Training also may incorporate overall guidelines for the group or organization implementing the methodology. For example, training may look to overall information technology guidelines for the HRIS, i.e., computer systems and standard software, that may require training. Another factor in developing training may be whether one person has performed the procedure for a long period of time. This information may be found on the procedural questionnaire, as disclosed above.

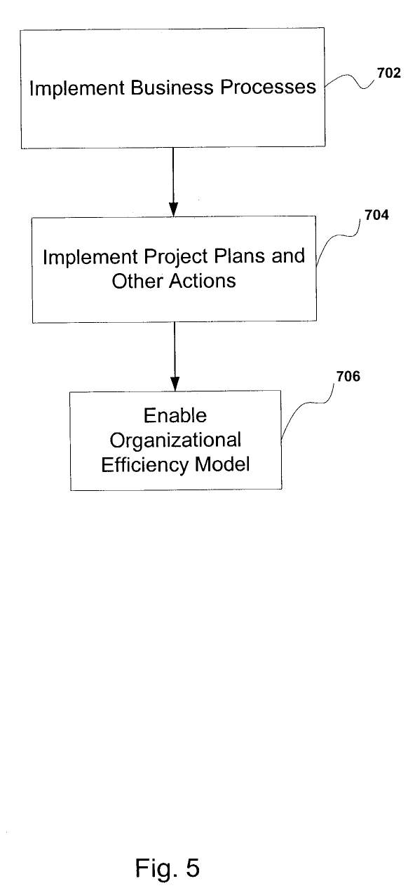

FIG. 5 depicts a flowchart for the implementation phase of the disclosed embodiments. FIG. 5 may disclose step 106 of FIG. 1 in greater detail. Step 106, however, is not limited to the disclosure pertaining to FIG. 5. Step 702 executes by implementing the business processes and the HRIS along with the organization efficiency model. The organizational efficiency model details who should be doing what in implementing the procedures developed by the disclosed methodology. In the model, the business process engineering procedures identified in the procedural questionnaires will be shown as a flow diagram. The diagram also may be broken into “lanes” or rows that indicates what organization is responsible for what procedures.

Step 704 executes by implementing project plans and other actions. Other actions may include preparing communication materials, and executing training sessions developed in the construction phase. The implementation phase also may follow up on the risk assessment strategies described in the construction phase. Further, project plans and communication materials may apply to each phase disclosed.

Step 706 executes by enabling the organizational efficiency model and may use other operations or processes to feed into the model. Further, the model may be broken down into sub-components, or smaller models. In other words, the overall model developing by the disclosed methodology may comprise independent, smaller models. For example, if the overall organization efficiency model is for human resources, the overall model may include a model for hiring/personnel issues, or “jobs express”, a network implementation of the different HR procedures, and different processes depending on the type of employee at the company. For example, different processes may be enacted for managers and employees, or associates. These separate procedures all may be developed using business process engineering.

Thus, referring to the different procedural questionnaires, the processes may be identified according to the disclosed methodology. The processes are placed in an organization efficiency model. The model depicts the processes in a flow and the responsibility of the processes. The processes may be independent from each other.

Referring back to FIG. 1, step 108 executes the post-implementation phase of the disclosed embodiments. The post-implementation phase seeks to improve the enacted processes. One operation is measuring the key performance indicators that were described in the procedural questionnaire. Key performance indicators may use measurements or scorecards to determine how effective the implemented processes are. Other operations during the post-implementation phase may include optimizing the business process and improving the organization efficiency model. Further, the requests log may be changed.

In addition to the phases disclosed above, additional processes may occur while the phases are being executed. These processes may be pervasive over the entire disclosed methodology. For example, as disclosed in step 110, one process may be communication to key stakeholders of the project about the different phases and processes or about the status of the implementation of the methodology. The presentations, or communications, may or may not occur according to set schedules.

Step 112 executes the progress monitoring phase of the disclosed embodiments. Progress monitoring measures and keeps track during the disclosed methodology of the overall process. Progress monitoring may be completed by filling out spreadsheets or other documents that allow data to be input over different time periods to monitor success or failure. Referring back to the project plans, progress monitoring relates to timely execution and the budgetary constraints of the project plans.

Step 114 executes the change management phase of the disclosed embodiments. Change management also may occur during the disclosed methodology. Change management may track the difference between old and new processes. As noted above, looking at processes AS IS and TO BE. Information for change management may be gathered from the procedural questionnaire. The information may be known as procedure effectiveness. Example information may be constraints, issues, follow up questions, recommendations, and supporting documentation. Change management also may include gaps analysis and impact analysis. Project plans and communication materials also may apply to progress monitoring and change management as disclosed above with reference to the implementation phase.

It will be apparent to those skilled in the art that various modifications and variations can be made to present invention without departing from the spirit or scope of the invention. Thus, it is intended that the present invention covers the modifications and variations of this invention provided that they come within the scope of any claims and their equivalents.

What is claimed:

1. A method for designing and implementing human resources business procedures within a company, comprising:
discovering a business process by performing business process engineering and receiving information pertaining to the business process;
constructing the business process according to the information;
implementing the business process and an organization efficiency model developed according to the business process engineering; and
improving the business process according to key performance indicators from the information.

2. The method of claim 1, wherein the information is a questionnaire.

3. The method of claim 1, further comprising communicating to key stakeholders about a status of the method.

4. The method of claim 1, further comprising monitoring progress of the method.

5. The method of claim 1, further comprising performing change management.

6. The method of claim 1, wherein said discovering includes performing a first assessment of the business process.

7. The method of claim 1, wherein said discovering includes performing project preparation.

8. The method of claim 1, wherein said discovering includes selecting vendors.

9. The method of claim 1, wherein said discovering includes preparing and defining audits for the organization efficiency model.

10. The method of claim 1, wherein said constructing includes writing business and technical specifications.

11. The method of claim 1, wherein said constructing includes constructing information technology specifications.

12. The method of claim 1, wherein said constructing includes changing a request log.

13. The method of claim 1, wherein said constructing includes testing.

14. The method of claim 13, wherein said testing includes user acceptance testing.

15. The method of claim 1, wherein said constructing includes performing training operations.

16. The method of claim 1, wherein said implementing includes implementing project plans.

17. The method of claim 1, wherein said implementing includes enabling the organizational efficiency model.

18. A method for implementing a business process, comprising:
identifying a process according to received feedback;
placing the process in an organization efficiency model;
depicting the process in a flow, wherein the flow includes the responsibilities of the process; and testing scenarios within the process.

19. The method of claim 18, wherein said testing includes user acceptance testing.

20. The method of claim 19, wherein said user acceptance testing includes identifying critical acceptance criteria.

21. The method of claim 19, wherein said user acceptance testing includes defining a scope of the testing.

22. The method of claim 19, wherein said user acceptance testing includes developing objectives and materials.

23. The method of claim 19, wherein said user acceptance testing includes building test scripts.

24. The method of claim 18, further comprising using business process engineering to identify the process.

25. A method for designing and implementing an improved process over an existing process having a starting point and an ending point in a business environment, wherein the process is depicted by a business model, comprising:
creating a conceptual flow diagram for the process to communicate redesign of the existing process;
designing the improved process to minimize steps within the business model;
identifying and sequencing major activities that link the starting point to the ending point;
determining detailed requirements for the improved process; and
implementing the improved process according to the conceptual flow diagram.
